(19) United States
(12) Patent Application Publication
(10) Pub. No.: US 2004/0224171 A1
(43) Pub. Date: Nov. 11, 2004

(54) Electrochemically roughened aluminum semiconductor chamber surfaces

(76) Inventors: Jennifer Y. Sun, Sunnyvale, CA (US); Clifford C. Stow, Santa Clara, CA (US); Senh Thach, Union City, CA (US)

Correspondence Address: Patent Counsel, Applied Materials, Inc., P.O. Box 450 A, Santa Clara, CA, 95052, US

(21) Appl. No.: 10/866,470

(22) Filed: Jun. 10, 2004

Related U.S. Application Data
(63) Continuation of application No. 09/918,683, filed on Jul. 27, 2001.

(51) Int. Cl. B32B 15/04; B32B 9/00

(52) U.S. Cl. 428/469; 428/336

(57) ABSTRACT

A uniform, controllable method for electrochemically roughening an aluminum-comprising surface to be used in a semiconductor processing apparatus is disclosed Typically the aluminum-comprising surface is aluminum or an aluminum alloy. The method involves immersing an aluminum-comprising surface in an HCl solution having a concentration ranging from about 1, volume % to about 5 volume %, at a temperature within the range of about 45° C. to about 80° C., then applying an electrical charge having a charge density ranging from about 80 amps/ft.² to about 250 amps/ft.² for a time period ranging from about 4 minutes to about 25 minutes. A chelating agent may be added to enhance the roughening process. The electrochemical roughening method can be used on aluminum alloys in general, including but not limited to 6061 and LP. The electrochemical roughening provides a smoothly rolling surface which does not entrap particles and which provides increased surface area for semiconductor process byproduct adhesion. The roughened surface provides an excellent surface for subsequent anodization.

### BACKGROUND OF THE INVENTION

1. Field of the Invention

The present invention pertains to an electrochemically roughened aluminum or aluminum alloy surface for use within a semiconductor processing chamber. The present invention also pertains to a method of electrochemically roughening an aluminum or aluminum alloy surface. The roughened surface is typically anodized to provide a finished surface for use in semiconductor processing.

2. Brief Description of the Background Art

Semiconductor manufacturing processes, such as etch and deposition processes, utilize a wide variety of processing gases and substrate materials. Highly volatile process byproducts are typically removed from the processing chamber by application of vacuum. Less volatile byproducts may adhere to the interior surface of the processing chamber or may redeposit on the surface of the semiconductor substrate being processed. Most semiconductor manufacturers prefer to have redepositing byproducts deposit on processing chamber surfaces (rather than the substrate). The processing chamber surfaces are then periodically cleaned. Frequent chamber cleanings are expensive in terms of processing chamber downtime. The more redeposited byproducts which can be held by the processing chamber surfaces, the less frequent the cleaning requirement.

Interior surfaces of semiconductor processing chambers are frequently aluminum. One prior art semiconductor processing chamber includes anodized aluminum surfaces which have been lapped to have a surface roughness of only 4 Ra, which is essentially a mirror finish. However, when subjected to the high temperatures and processing conditions used in many semiconductor manufacturing processes, the highly polished, anodized aluminum surface developed numerous tiny cracks in the anodized layer, known as craze lines; these are shown in FIG. 1. While the craze lines 100 typically do not penetrate all of the way through the anodized layer to the boundary layer at the base aluminum beneath, they tend to spread across the anodized surface, producing a spider web pattern. During a fluorine-based etch process, the anodized aluminum surface reacts with fluorine gas, causing the craze lines to fill with a self-passivating fluoride. Although the craze lines may not interfere with the operation of the chamber during a fluorine-based etch process, they are cosmetically unappealing, and the user of the processing chamber tends to worry that fluorine-containing species may be passing through the protective anodized layer and corroding the aluminum surface beneath. Further, in a non-fluorine-based environment (such as during a chlorine-based etch process), the craze lines do not fill with self-passivating fluoride and the anodized surface may eventually fail, exposing the aluminum beneath to corrosion by chlorine-containing species.

During a number of semiconductor processing procedures, byproducts are formed which are not sufficiently volatile to be removed by the vacuum system of the processing chamber. In many instances, it is desirable to provide a surface inside the processing chamber on which these byproducts are capable of adhering, so that they will not fall upon semiconductor workpieces during processing, causing contamination.

One method of improving the adhesion of semiconductor processing byproducts to an aluminum surface within a semiconductor processing chamber is to provide a roughened surface to which byproducts generated during processing can stick. Typically, aluminum semiconductor chamber surfaces have been roughened by bead blasting. However, bead blasting often is a manual process, in which it is difficult to control the uniformity and repeatability. Further, bead blasting typically provides a very sharp, jagged surface 200 on the aluminum, as shown in FIG. 2. Tips of the roughened aluminum can curl over, forming hook-shaped projections 202 which can break off or entrap particles 204, including the bead blast particle itself. As a result, the bead blasting media may act as a source of contamination of the aluminum surface. Bead blasting is not useful as a roughening method for some of the softer aluminum alloys, such as the 1000 series, because the bead blasting particles can easily become embedded in the ductile metal. Further, the sharp surface provided by bead blasting may complicate a subsequent anodization process.

It would therefore be desirable to provide a uniform and controllable method for roughening an aluminum surface which could be used for all aluminum alloys. In particular, the roughening method should provide a surface which does not entrap particles, is free from jagged and hooked surface formations, and is easily anodized.

### SUMMARY OF THE INVENTION

Applicants have discovered a uniform, controllable method for electrochemically roughening an aluminum-comprising surface intended for use within a semiconductor processing chamber. Typically the aluminum-comprising surface is aluminum or an aluminum alloy. Applicants have also determined that if they electrochemically roughen an aluminum or aluminum alloy surface, they avoid the formation of jagged and hooked surface topography. The surface which is formed by the electrochemical roughening provides a topography which resembles small rolling hills and valleys. The estimated average height of the hills above the valleys is approximately 16 μm; the estimated average distance between the hills is approximately 50 μm, depending on the grade of the aluminum. Typically, the height of the hills ranges from about 8 μm to about 25 μm, and the distance between the center of one hill and that of an adjacent hill ranges from about 30 μm to about 100 μm.

Surprisingly, the hill and valley topography obtained by electrochemically roughening an aluminum or aluminum alloy surface relieves stress in an anodized finish subsequently produced over the roughened surface, so that the anodized layer does not crack upon thermal cycling up to about 300° C. In addition, unexpectedly, the amount of redepositing byproduct which can be accumulated over the hills and valleys (including an anodized surface which mirrors the underlying aluminum surface) is drastically increased over that which can be accumulated over a bead-blasted surface. As a result, the number of substrate processing cycles prior to cleaning with the new, electrochemically roughened, aluminum or aluminum alloy anodized surface is about 5 times greater than with the bead blasted aluminum anodized surface.

Applicants' method for surface roughening can be used on aluminum and aluminum alloys in general, including but not limited to 6061 and LP (available from Alcai Alusuisse). Applicants' method promotes formation of a smooth, rolling-hilled, anodized surface which does not entrap particles. Further, applicants' electrochemically roughened aluminum-comprising surfaces provide increased surface area for collection of redepositing byproducts.

### BRIEF DESCRIPTION OF THE DRAWINGS

FIG. 1 shows a prior art anodized aluminum surface 100 which has been lapped to have a surface roughness of 4 Ra. Note the many craze lines 102 which have formed in the aluminum surface subsequent to exposure to process conditions, producing a spider web pattern.

FIG. 2 shows a prior art aluminum surface 200 which has been roughened using bead blasting. Note the many hook-shaped projections 202 which can break off or entrap particles 204, including the bead blast particle itself.

FIG. 3 shows an aluminum surface 300 which has been roughened using applicants' electrochemical roughening method. Note the smooth, rolling topography of applicants' electrochemically roughened aluminum surface.

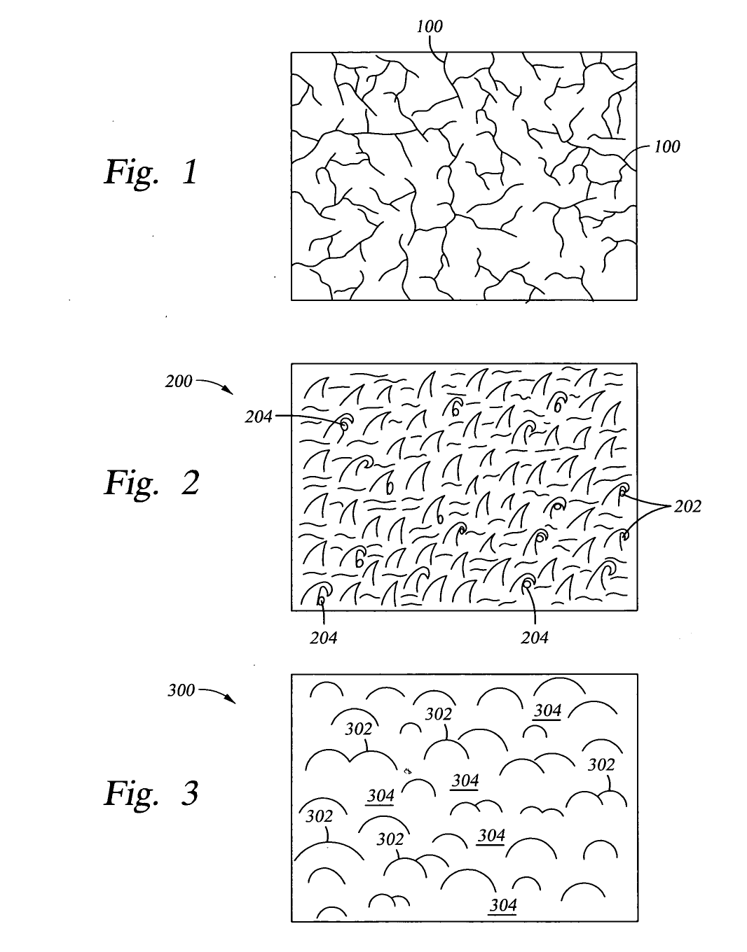

### DETAILED DESCRIPTION OF THE PREFERRED EMBODIMENTS

Applicants' invention pertains to a method of electrochemically roughening an aluminum-comprising surface. Typically the aluminum-comprising surface is aluminum or an aluminum alloy. Aluminum is commonly alloyed with elements such as silicon, copper, zinc, magnesium, manganese, iron, titanium, and nickel, by way of example, and not by way of limitation. Applicants' invention has use in semiconductor processing chambers which include electrochemically roughened aluminum surfaces, and particularly roughened surfaces having a protective coating thereover, such as an anodized aluminum coating.

Applicants' method for electrochemically roughening an aluminum-comprising surface comprises immersing the aluminum-comprising surface in an aqueous HCl solution having a concentration ranging from about 1 volume % to about 5 volume % at a temperature ranging from about 45° C. to about 80° C., then applying an electrical charge having a charge density ranging from about 80 amps/ft.² to about 250 amps/ft.² for a time period ranging from about 5 minutes to about 25 minutes. Chelating agents (such as, for example, but without limitation, gluconic acid, available from VWR Scientific Products, West Chester, Pa.) may be added to the HCl solution to control the bath chemistry and conductivity.

Typical processing conditions for electrochemically roughening aluminum and aluminum alloys according to applicants' method are presented in Table One, below.

TABLE ONE
Typical Process Conditions for Electrochemically Roughening
Aluminum and Aluminum Alloys

| | Typical | Preferred | Optimum |
|---|---|---|---|
| | Process | Process | Known Process |
| Process Parameter | Conditions | Conditions | Conditions |
| HCl Concentration (% volume) | 1-5 | 1-3 | 1-1.5 |
| Chelating Agent (% volume) | 0.5-3 | 0.5-1.5 | 0.8-1.2 |
| Tank Temperature (° C.) | 45-80 | 50-70 | 55-65 |
| AC Frequency (Hz) | 60-120 | 80-100 | 85-95 |
| Charge Density (amps/ft.²) | 80-250 | 120-250 | 150-250 |
| Time (min.) | 4-25 | 4-20 | 4-20 |

Processing conditions will need to be adjusted depending on the specific chemical composition of the particular aluminum alloy being roughened. Applicants have performed electrochemical roughening of several commercially available aluminum alloys. Specific processing conditions used during the electrochemical roughening of these alloys are presented in Table Two, below.

TABLE TWO
Process Conditions for Electrochemically Roughening
Particular Aluminum Alloys

| Alloy | | |
|---|---|---|
| Process Condition | 6061* | LP** |
| HCl Concentration (% volume) | 1.0-1.5 | 1.0-1.5 |
| Gluconic Acid*** (% volume) | 0.9-1.1 | 0.9-1.1 |
| (Chelating Agent) | | |
| Tank Temperature (° C.) | 55-65 | 55-65 |
| AC Frequency (Hz) | 85-95 | 85-95 |
| Charge Density (amps/ft²) | 175-250 | 175-250 |
| Time (min.) | 6-12 | 4-8 |

*Can be obtained from any of the major aluminum manufacturers, such as Alcoa (Pittsburgh, PA), Alcan, Inc. (Montreal, Canada), and Reynolds Aluminum Supply Co. (Richmond, VA).
**Obtained from Alcan Alusuisse (Stegen, Germany).
***Obtained from VWR Scientific Products (West Chester, PA).

Unroughened, machined aluminum and aluminum alloy typically has a surface roughness ranging from about 12 Ra to about 32 Ra. After performing applicants' electrochemical roughening method, the aluminum or aluminum alloy-surface typically has a surface roughness ranging from about 100 Ra to about 200 Ra, preferably ranging from about 110 Ra to about 160 Ra.

As shown in FIG. 3, applicants' aluminum and aluminum alloy roughening method provides a surface 300 having a topography resembling small rolling hills and valleys. The estimated average height of the hills above the valleys is approximately 16 μm; the estimated average distance between the hills is approximately 50 μm, depending on the grade of the aluminum. Typically, the height of the hills ranges from about 8 μm to about 25 μm, and the distance between the center of one hill and that of an adjacent hill ranges from about 30 μm to about 100 μm. Applicants' electrochemically roughened aluminum or aluminum alloy surface provides increased surface area for collection of redepositing byproducts, but does not entrap particles.

Applicants' electrochemical roughening method is particularly useful for roughening aluminum and aluminum alloy surfaces which are subsequently protected by a plasma-resistant coating, for use within semiconductor processing chambers, such as an etch chamber or a deposition chamber. Applicants' method is particularly useful for roughening any apparatus surface which comes into contact with semiconductor processing byproducts. Applicants' electrochemically roughened aluminum or aluminum alloy surface provides pockets in the hills and valleys which provide for the accumulation of semiconductor processing byproducts, such as etch byproducts or CVD deposition byproducts, preventing the byproducts from redepositing on the surface of the semiconductor substrate being processed. It is helpful to use a protective coating applied over the aluminum ro aluminum alloy surface which provides for adhesion of depositing byproducts. Example protective coatings include anodic oxide, flame spray-deposited aluminum oxide, and other ceramic coatings which may be conductive or non-conductive.

In particular, during a fluorine-based etch process, fluorine and carbon from the etch process react to form a polymer which easily adheres to an electrochemically roughened, anodized aluminum surface.

Applicants' electrochemically roughened, anodized aluminum or anodized aluminum alloy surfaces can be included in etch chambers which are used for etching dielectric materials (including inorganic dielectric materials, such as silicon oxide, silicon nitride, silicon oxynitride, and tantalum pentoxide, and organic dielectric materials, such as an organic low-k dielectric material), metals (such as aluminum, copper, titanium, tantalum, and tungsten), and polysilicon, by way of example, and not by way of limitation.

Applicants' method can be used to create roughened surfaces for semiconductor processing chamber components such as wall liners, cathode liners, slit valve doors, slit valve liners, buffer inserts, and gas distribution plates, by way of example, and not by way of limitation.

Anodization of applicants' electrochemically roughened aluminum and aluminum alloy surfaces can be performed using conventional aluminum anodization techniques known in the art, such as by following Mil Standard No. A-8625F, by way of example, and not by way of limitation. Because applicants' roughening method relieves stress within the aluminum or aluminum alloy surface, the resulting anodized surface does not form craze lines, even when subjected to the temperature cycling which occurs due to particular semiconductor manufacturing processes.

Other protective, plasma-resistant coatings, such as flame spray-deposited aluminum oxide and other ceramic coatings, can be deposited or applied over a roughened aluminum or aluminum alloy surface using teclniques known in the art. Ceramic coatings, either conductive or non-conductive, may be applied over a roughened, anodized surface.

The above described preferred embodiments are not intended to limit the scope of the present invention, as one skilled in the art can, in view of the present disclosure expand such embodiments to correspond with the subject matter of the invention claimed below.

1. A semiconductor processing chamber, where a surface of previously unroughened aluminum or aluminum alloy has been roughened using electrochemical treatment of said surface in a manner such that said surface has the appearance of rolling hills and valleys, when magnified, whereby a protective layer formed over said roughened surface does not crack upon thermal cycling up to about 300° C.

2. The semiconductor processing chamber of claim 1, wherein said at least one interior surface has a surface roughness ranging from about 100 μm Ra to about 200 μm Ra.

3. The semiconductor processing chamber of claim 2, wherein said surface roughness ranges from about 110 μm Ra to about 160 μm Ra.

4. (Cancelled)

5. The semiconductor processing chamber of claim 1, wherein the height of said hills ranges from about 8 μm to about 25 μm.

6. The semiconductor processing chamber of claim 1 or claim 5, wherein the distance between the center of one hill and the center of an adjacent hill ranges from about 30 μm to about 100 μm.

7. The semiconductor processing chamber of claim 1, wherein said electrochemically roughened aluminum or aluminum alloy surface underlies a protective layer selected from the group consisting of an anodized layer, a flame spray-deposited aluminum oxide coating, a ceramic coating, and an anodized layer having a ceramic coating applied thereover.

8. The semiconductor processing chamber of claim 1 or claim 7, wherein byproducts generated during an etch process or a deposition process adhere to said electrochemically roughened aluminum or aluminum alloy surface or to said protective layer overlying said electrochemically roughened aluminum or aluminum alloy surface.

9. The semiconductor processing chamber of claim 1, wherein said semiconductor processing chamber is selected from the group consisting of an etch chamber and a deposition chamber.

10. The semiconductor processing chamber of claim 9, wherein said semiconductor processing chamber is an etch chamber which is used for etching a material selected from the group consisting of a dielectric material, a metal, and polysilicon.

11. The semiconductor processing chamber of claim 9, wherein said semiconductor processing chamber is an etch chamber, and wherein fluorine and carbon from an etch process react to form a polymer which adheres to said electrochemically roughened aluminum surface.

12. A processing component for use within a semiconductor processing chamber, wherein at least one surface of said processing component comprises aluminum or an aluminum alloy, and wherein at least one previously unroughened aluminum or aluminum alloy surface has been electrochemically roughened so that said at least one aluminum or aluminum alloy surface has the appearance of rolling hills and valleys, when magnified.

13. The processing component of claim 12, wherein said electrochemically roughened aluminum or aluminum alloy surface has a surface roughness ranging from about 100 μm Ra to about 200 μm Ra.

14. The processing component of claim 13, wherein said surface roughness ranges from about 110 μm Ra to about 160 μm Ra.

15. (Cancelled)

16. The processing component of claim 12, wherein the height of said hills ranges from about 8 μm to about 25 μm.

17. The processing component of claim 12 or claim 16, wherein the distance between the center of one hill and the center of an adjacent hill ranges from about 30 μm to about 100 μm.

18. The processing component of claim 12, wherein said electrochemically roughened aluminum or aluminum alloy surface underlies a protective layer selected from the group consisting of anodized layer, a flame spray-deposited aluminum oxide coating, a ceramic coating, and an anodized layer having a ceramic coating applied thereover.

19. The processing component of claim 12 or claim 18, wherein byproducts generated during an etch process or a deposition process adhere to said electrochemically roughened aluminum or aluminum alloy surface or to said protective layer overlying said electrochemically roughened aluminum or aluminum alloy surface.

20. The processing component of claim 12, wherein said processing component is used within a semiconductor processing chamber selected from the group consisting of an etch chamber and a deposition chamber.

21. The processing component of claim 20, wherein said semiconductor processing chamber is an etch chamber which is used for etching a material selected from the group consisting of a dielectric material, a metal, and polysilicon.

22. The processing component of claim 20, wherein said semiconductor processing chamber is an etch chamber, and wherein fluorine and carbon from an etch process react to form a polymer which adheres to said electrochemically roughened surface.

23. The processing component of claim 12, wherein said processing component is selected from the group consisting of: a wall liner, a cathode liner, a slit valve door, a slit valve liner, a buffer insert, and a gas distribution plate.

24. A semiconductor processing apparatus surface, wherein said surface is a previously unroughened aluminum or aluminum alloy surface which has been electrochemically roughened so that said surface has the appearance of rolling hills and valleys, when magnified.

25. The semiconductor processing apparatus surface of claim 24, wherein said surface has a surface roughness ranging from about 100 μm Ra to about 200 μm Ra.

26. The semiconductor processing apparatus surface of claim 25, wherein said surface roughness ranges from about 110 μm Ra to about 160 μm Ra.

27. (Cancelled)

28. The semiconductor processing apparatus surface of claim 24, wherein the height of said hills ranges from about 8 μm to about 25 μm.

29. The semiconductor processing apparatus surface of claim 24 or claim 28, wherein the distance between the center of one hill and the center of an adjacent hill ranges from about 30 μm to about 100 μm.

30. The semiconductor processing apparatus surface of claim 24, wherein said surface underlies a protective layer selected from the group consisting of anodized layer, a flame spray-deposited aluminum oxide coating, a ceramic coating, and an anodized layer having a ceramic coating applied thereover.

31. The semiconductor processing apparatus surface of claim 24 or claim 30, wherein byproducts generated during an etch process or a deposition process adhere to said electrochemically roughened aluminum or aluminum alloy surface or to said protective layer overlying said electrochemically roughened aluminum or aluminum alloy surface.

32. The semiconductor processing apparatus surface of claim 31, wherein fluorine and carbon from an etch process react to form a polymer which adheres to said surface.

33. The semiconductor processing apparatus surface of claim 24, wherein said surface is present on an apparatus component selected from the group consisting of: a wall liner, a cathode liner, a slit valve door, a slit valve liner, a buffer insert, and a gas distribution plate.
